(19) United States
(12) Patent Application Publication
(10) Pub. No.: US 2026/0022983 A1
(43) Pub. Date: Jan. 22, 2026

(54) System and Method for Measuring Torque

(71) Applicant: Tejas Tubular Products, Inc., Houston, TX (US)

(72) Inventors: Rick Nichols, Houston, TX (US); Maximo Tejeda, Houston, TX (US); Maximo Tejeda, JR., Houston, TX (US)

(21) Appl. No.: 19/274,802

(22) Filed: Jul. 21, 2025

Related U.S. Application Data
(60) Provisional application No. 63/673,867, filed on Jul. 22, 2024.

(51) Int. Cl. G01L 5/24

(52) U.S. Cl. CPC G01L 5/24

(57) ABSTRACT

A system for measuring torque in hydraulically powered tongs. The system including a pressure transducer, a dump valve, and a controller. The pressure transducer measures the pressure in the hydraulic line of the tongs and sends the data to the controller. The controller converts the data to torque measurements and reports it to a user device. If the torque measurements exceed a certain amount, the controller signals the dump valve to open.

### CROSS REFERENCE TO RELATED APPLICATION

This application claims priority to U.S. Application No. 63/673,867 filed on Jul. 22, 2024, the disclosure of which is incorporated herein by reference for all purposes.

### FIELD OF THE INVENTION

The present invention relates to a system for measuring torque. In particular, the present invention relates to a system for measuring make-up/break-out torque of threaded pipe connections in the oil and gas industry.

### BACKGROUND OF THE INVENTION

In the oil and gas industry, hydraulically powered wrenches known as tongs are used to make up and break casing and tubing connections. When making up connections, it is important to know the amount of torque being applied to ensure a proper connection. Typically, when torque reporting is required, a subcontractor brings in specially designed tongs having torque and turn sensors, tension load cells or pancake load cells, and which are operated by proprietary software systems. This specialized service greatly increases the cost of the overall operation.

### SUMMARY OF THE INVENTION

In one aspect, the present invention relates to a system for measuring the torque of hydraulic tongs.

In another aspect, the present invention relates to a system for measuring the torque of hydraulic tongs which can be retrofit to existing oilfield systems.

### BRIEF DESCRIPTION OF THE DRAWINGS

FIG. 1 depicts one embodiment of the system of the present invention.

FIG. 2 shows one example of the torque measurements displayed by the system of the present invention.

FIG. 3 shows another example of the torque measurements displayed by the system of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

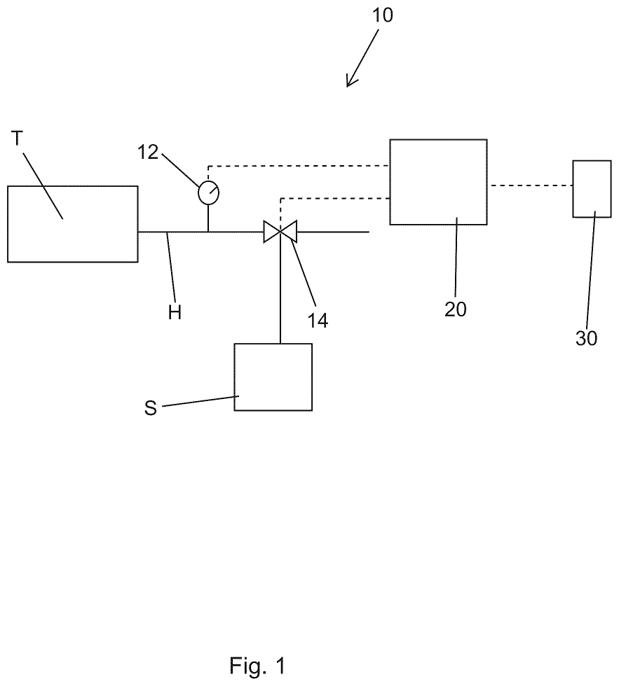

FIG. 1 depicts one embodiment of the system 10 of the present invention. The system 10 includes a pressure transducer 12 connected to the hydraulic line H of oilfield tongs T. In a preferred embodiment, the pressure transducer 12 is digital with a visual display. Pressure transducer 12 is operatively connected, through a wired or wireless connection, to a controller 20 (e.g., a programmable logic controller). Pressure transducer 12 transmits real time measurements of the fluid pressure in the hydraulic system of tongs to the controller 20. Controller 20 converts the pressure measurements to a measurement of torque produced by tongs and saves the information. In a preferred embodiment, controller 20 is connected, by wired or wireless connection, to a user device 30. User device 30 may comprise a PC, laptop, mobile phone, tablet, flash drive, printer, or any other device operated by users to manage data.

In addition to measuring the torque of the tongs, the system 10 of the present invention preferably includes a dump valve 14 operatively connected to the tongs and the controller 20. If the measured torque exceeds a certain amount, the controller 20 opens the dump valve. The hydraulic fluid is then drained from the tongs and the make-up operation stopped.

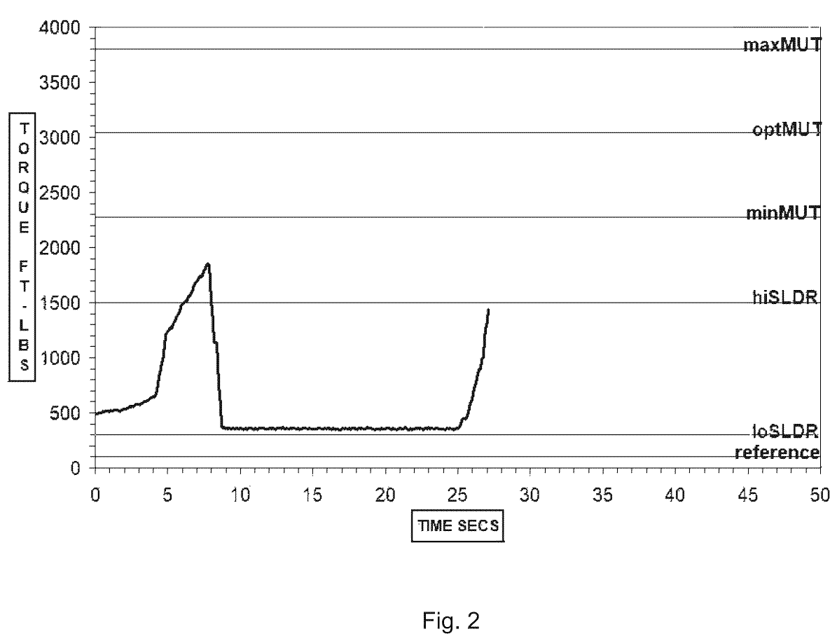

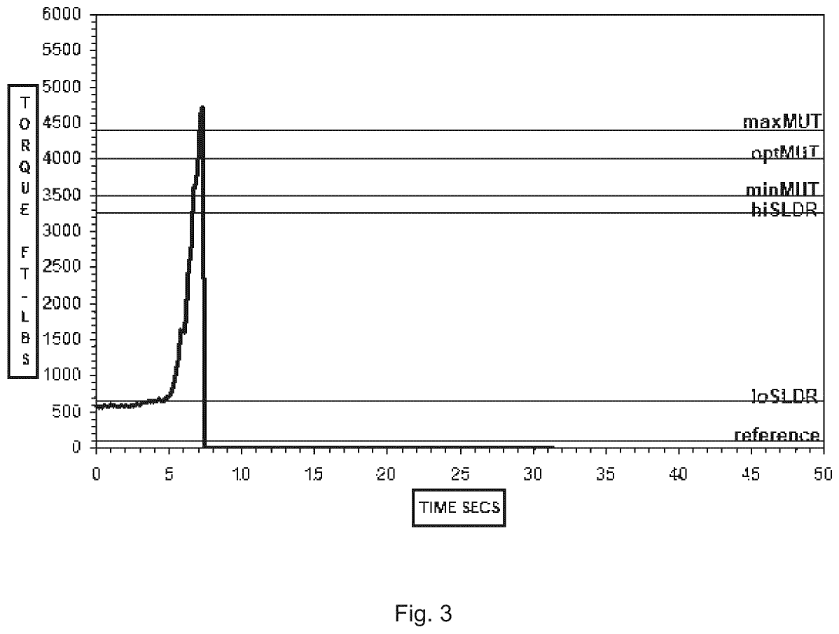

The system can provide real time data of the torque generated by the tongs. The system of the present invention preferably generates periodic reports of the torque data, the frequency and contents of which can be determined by the needs of the user. FIGS. 2 and 3 show examples of the torque generated by the tongs. As shown in FIG. 2, the torque rises and falls over time. As can be seen in FIG. 3, the torque exceeded the maximum amount allowed, triggering the dump valve. The torque then immediately dropped back down to zero as the fluid was drained away to a storage tank S, recycle tank, or the like.

In use, the system 10 of the present invention is installed on existing tongs. The make-up torque parameters for the particular casing/pipe/coupling of the particular operation are entered into the controller so that the maximum permitted torque can be determined.

The system 10 of the present invention provides several advantages over the prior art. The system 10 can be retrofit onto any prior tong system and is more cost effective than the prior art torque-turn tongs. The system 10 does not require any load cells of any kind. The automated dump valve improves safety by ceasing the torque operations without endangering personnel, and reduces costs by avoiding damage caused by over-torquing connections. The constant monitoring of the system allows for an improved maintenance schedule. Consistently lower-than-expected pressure measurements can indicate a leak in the hydraulics system. Such leak can be repaired before causing major damage to the system.

It will be appreciated that typical components, conduits, cables, and the like required to operate the system may not be depicted herein but are well known to those skilled in the art.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A system for measuring the torque of tongs powered by a hydraulic system, comprising:
a pressure transducer operatively connected to the hydraulic system of the tongs to measure pressure therein;
a dump valve operatively connected to the hydraulic system of the tongs;
a controller operatively connected to the pressure transducer and the dump valve;
the controller programmed to receive pressure measurements from the pressure transducer and to convert the pressure measurements into torque measurements.

2. The system of claim 1, wherein if the torque measurements exceed a certain amount, the controller signals the dump valve to open.

3. The system of claim 1, wherein the controller sends the torque measurements to a user device.
